(19) United States
(12) Patent Application Publication
(10) Pub. No.: US 2007/0071633 A1
(43) Pub. Date: Mar. 29, 2007

(54) Hydrogen storage alloy

(75) Inventors: Masaru Kihara, Takasaki-shi (JP); Takahiro Endo, Takasaki-shi (JP); Tatsuya Aizawa, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/523,085

(22) Filed: Sep. 19, 2006

(30) Foreign Application Priority Data
Sep. 20, 2005 (JP) 2005-271941

(51) Int. Cl. H01M 4/58; C22C 19/03

(52) U.S. Cl. 420/455; 429/218.2; 420/900

(57) ABSTRACT

A hydrogen storage alloy has a composition expressed by a general formula: Ln_{1-α}Mg_{α(Ni}_{1-β}T_{β})_{γ}. In the formula, Ln is at least one element selected from a group consisting of La, Ce, etc.; T is at least one element selected from a group consisting of V, Nb, etc.; subscripts α, β and γ are numeric values that satisfy 0.05<α<0.12, 0.05≦β≦0.5, 3.40≦γ≦3.70, respectively. The hydrogen storage alloy satisfies at least one of three conditions that (1) the proportion of La in Ln is 30 percent by mass or less; (2) the proportion of Ca in Ln is 25 percent by mass or less; and (3) the proportion of Al in the hydrogen storage alloy is 2.5 percent by mass or less.

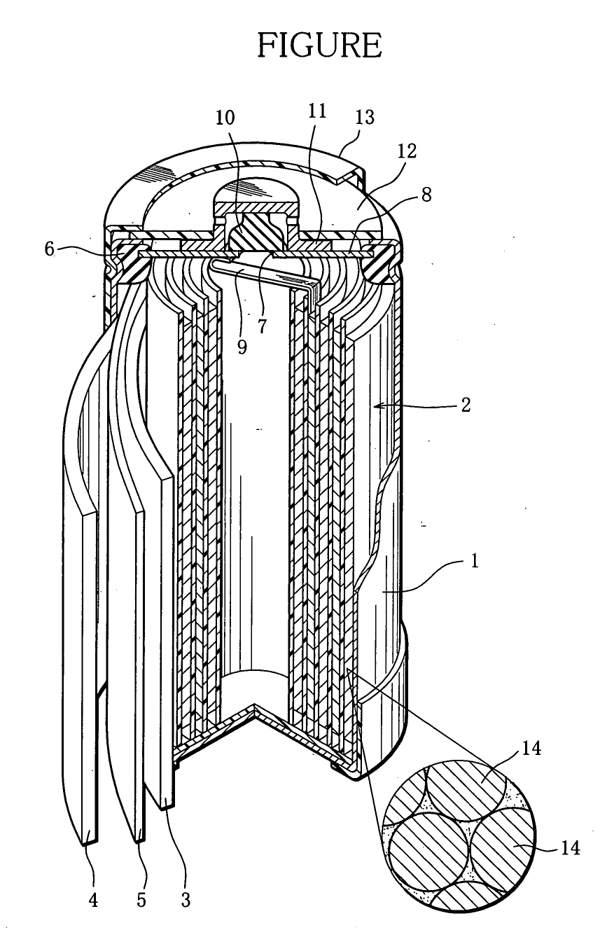

### BACKGROUND OF THE INVENTION

1. Field of the Invention

The present invention relates to hydrogen storage alloys, and more specifically, to hydrogen storage alloys suitable for use in alkaline storage batteries.

2. Description of the Related Art

An alkaline storage battery using a hydrogen storage alloy for its negative electrode is in great demand as a consumer battery because of its properties such that it has high capacity and that it is cleaner than batteries using lead or cadmium.

Generally, for an alkaline storage battery of this type, an AB₅-type (CaCu₅-type) hydrogen storage alloy such as LaNi₅ is used. The discharge capacity of such a battery, however, is more than 80 percent of its theoretical capacity, so that there is a limitation to further enhancement of the capacity.

Given this factor, for the purpose of increasing the capacity, an alkaline storage battery has been being developed, which employs a rare earth-Mg—Ni-based hydrogen storage alloy that is obtained by substituting Mg element for part of rare earth element contained in an AB₅-type hydrogen storage alloy. For instance, Unexamined Japanese Patent Application Publication No. 2002-164045 discloses a rare earth-Mg—Ni-based hydrogen storage alloy having the composition that is expressed by the following general formula and conditional expression:
(R_{1-a-b}LaₐCe_{b})_{1-c}Mg_{c}Ni_{Z-X-Y-d-e}MnₓAl_{Y}Co_{d} Mₑ
c=(−0.025/a)+f,
where R is at least one element selected from a group consisting of rare earth elements including Y and Ca (excluding La and Ce); M is one or more elements selected from a group consisting of Fe, Ga, Zn, Sn, Cu, Si, B, Ti, Zr, Nb, W, Mo, V, Cr, Ta, Li, P and S; and atomic ratios a, b, c, d, e, f, X, Y and Z are defined as 0<a≦0.45, 0≦b≦0.2, 0.1≦c≦0.24, 0≦X≦0.1, 0.02≦Y≦0.2, 0≦d≦0.5, 0≦e≦0.1, 3.2≦Z≦3.8, and 0.2≦f≦0.29.

Conventionally, the capacity enhancement of hydrogen storage alloys means the increase in a hydrogen storage capacity or discharge amount per unit mass. Since the volume of a battery is fixed, it can be considered proper to increase a hydrogen storage capacity per unit volume instead of per unit mass. However, unit mass has been used for the reason below.

In the process of manufacturing electrodes and alkaline storage batteries using hydrogen storage alloys, it is easier to control the amount of hydrogen storage alloys by mass (weight). Furthermore, the true densities of AB₅-type hydrogen storage alloys hardly change even if their compositions are varied. In other words, when two kinds of AB₅-type hydrogen storage alloys different in composition are compared to each other, they are virtually identical in volume as long as they are identical in mass. Therefore, to increase the hydrogen storage capacity per unit mass is substantially the same thing as to increase it per unit volume.

However, the present inventors repeatedly conducted various studies for improving the corrosion resistance of rare earth-Mg—Ni-based hydrogen storage alloys against alkaline electrolyte solutions, and found that the true densities of rare earth-Mg—Ni-based hydrogen storage alloys markedly changed depending on their composition. Based upon this finding, the inventors have arrived at the idea of developing a rare earth-Mg—Ni-based hydrogen storage alloy that is capable of storing a large amount of hydrogen per unit volume because of its true density higher than conventional alloys and is suitable for the miniaturization and capacity enhancement of alkaline storage batteries.

### SUMMARY OF THE INVENTION

It is an object of the present invention to provide a rare earth-Mg—Ni-based hydrogen storage alloy that is capable of storing a large amount of hydrogen per unit volume and is suitable for miniaturization and capacity enhancement of alkaline storage batteries.

In order to achieve the object, the present invention provides a hydrogen storage alloy having a composition expressed by a general formula (I):
Ln_{1-α}Mg_{α}(Ni_{1-β}T_{β})_{γ}

(where Ln is at least one element selected from a group consisting of La, Ce, Pr, Nd, Pm, Sm, Eu, Gd, Tb, Dy, Ho, Er, Tm, Yb, Lu, Ca, Sr, Sc, Y, Ti, Zr and Hf; T is at least one element selected from a group consisting of V, Nb, Ta, Cr, Mo, Mn, Fe, Co, Al, Zn, Ga, Sn, In, Cu, Si, P and B; and subscripts α, β, and γ are numeric values that satisfy 0.05<α<0.12, 0.05≦β≦0.5, 3.40≦γ≦3.70, respectively.) The hydrogen storage alloy satisfies at least one of the following three conditions:
(1) the proportion of La in Ln is 30 percent by mass or less;
(2) the proportion of Ca in Ln is 25 percent by mass or less; and
(3) the proportion of Al in the hydrogen storage alloy is 2.5 percent by mass or less.

The hydrogen storage alloy according to this invention is capable of storing a large amount of hydrogen per unit volume and has high capacity, since the hydrogen storage alloy comprises a rare earth-Mg—Ni-based hydrogen storage alloy.

As the hydrogen storage alloy not only has the composition expressed by the general formula (I) but also satisfies at least one of the three conditions (1) to (3), the alloy has a true density of 8.0 g/cm³ or more. Consequently, the hydrogen storage alloy has higher true density as compared to conventional rare earth-Mg—Ni-based hydrogen storage alloys, so that it is capable of storing a large amount of hydrogen per unit volume. That is to say, the hydrogen storage alloy has higher capacity than conventional rare earth-Mg—Ni-based hydrogen storage alloys. Therefore, the application of the hydrogen storage alloy to a negative electrode makes it possible to realize the miniaturization and capacity enhancement of alkaline storage batteries.

The hydrogen storage alloy preferably satisfies two conditions out of the above-mentioned three, and more preferably satisfies all the three conditions.

### BRIEF DESCRIPTION OF THE DRAWING

The present invention will become more fully understood from the detailed description given hereinbelow and the accompanying drawing which is given by way of illustration only, and thus, are not limitative of the present invention, and wherein:

The Figure is a perspective view, partially broken away, showing a nickel-metal hydride storage battery according to one embodiment of the present invention, and a circle in the Figure is a perspective view schematically showing part of a negative electrode in an enlarged scale.

### DETAILED DESCRIPTION OF THE PREFERRED EMBODIMENTS

In order to achieve the above-mentioned object, the present inventors repeatedly conducted various studies. They acquired knowledge that elements that effect a noticeable change in true density of a rare earth-Mg—Ni-based hydrogen storage alloy are Mg>Ca>Al>La in the order in which rate of change is high, and that the true density is decreased as the mass ratios of these elements in a hydrogen storage alloy are raised. The inventors also found that relationship between the true density of the hydrogen storage alloy and the mass ratio of the elements was expressed by the following relational expression:
True density=8.87−0.18×A−0.25×B−0.15×C−0.01×D
(where A is mass ratio of Ca; B is mass ratio of Mg; C is mass ratio of Al; and D is mass ratio of La). As a consequence, the inventors have conceived of the present invention.

The Figure shows a nickel-metal hydride storage battery to which a hydrogen storage alloy according to one embodiment of the present invention is applied.

This battery has an exterior can 1 in the shape of a cylinder with a bottom. An electrode assembly 2 is contained in the exterior can 1. The electrode assembly 2 is formed by spirally rolling up a positive electrode 3 and a negative electrode 4 with a separator 5 interposed therebetween. An outer end portion of the negative electrode 4 is disposed in an outermost circumference of the electrode assembly 2, as viewed in the spiral direction. The negative electrode 4 is electrically connected to an inner circumferential wall of the exterior can 1. In the exterior can 1, an alkaline electrolyte solution, not shown, is also contained.

As the alkaline electrolyte solution, for example, a mixture of a potassium hydroxide solution and a sodium hydroxide solution, a lithium hydroxide solution or the like may be used.

A circular cover plate 8 having a gas release hole 7 in the center is arranged inside an opening end of the exterior can 1 through a ring-shaped insulating gasket 6. The insulating gasket 6 and the cover plate 8 are fixed by caulking an opening edge of the exterior can 1. Between the positive electrode 3 of the electrode assembly 2 and an inner surface of the cover plate 8, there is disposed a positive lead 9 for electrically connecting the positive electrode 3 and the cover plate 8. In an outer surface of the cover plate 8, a rubber valve element 10 is placed to close the gas release hole 7. A cylindrical positive terminal 11 with a flange is so set as to surround the valve element 10.

Disposed on the opening edge of the exterior can 1 is a ring-shaped insulating plate 12. The positive terminal 11 protrudes through the insulating plate 12. Reference numeral 13 denotes an external tube. The external tube 13 covers an outer circumferential edge of the insulating plate 12, an outer circumferential surface of the exterior can 1, and an outer circumferential edge of a bottom wall of the exterior can 1.

The positive electrode 3 and the negative electrode 4 will be described below in detail.

The positive electrode 3 is made up of a conductive positive substrate and a positive mixture that is maintained by the positive substrate. As the positive substrate, for example, a net-like, sponge-like, fibrous or felt-like metal porous body that is coated with nickel may be used.

The positive mixture. contains nickel hydroxide powder serving as a positive active material, an additive, and a binder. As the nickel hydroxide powder, it is preferable to use powder in which an average valence of nickel is greater than 2 and at least part of or all the surface of each particle is covered with a cobalt compound. The nickel hydroxide powder may be a solid solution containing cobalt and zinc.

As conductive material, for example, powder such as a cobalt oxide, a cobalt hydroxide, and metallic cobalt may be used. As a binder, for example, carboxymethylcellulose, methylcellulose, PTFE dispersion, HPC dispersion or the like may be used.

The positive electrode 3 can be produced, for example, by kneading nickel hydroxide powder, conductive material, a binder and water to prepare slurry for a positive electrode; applying and filling a positive substrate with the slurry for a positive electrode; and rolling and cutting the positive substrate after the slurry is dried.

The negative electrode 4 is consisting of a conductive negative substrate and a negative mixture that is maintained by the negative substrate. As the negative substrate, for example, a punching metal may be used.

The negative mixture contains hydrogen storage alloy powder, a binder, and conductive material as appropriate. For the binder, the same substance as that used for the positive-electrode mixture can be used, where another substance such as sodium polyacrylate can be used together. Carbon powder, for example, may be used as the conductive material. The Figure diagrammatically shows, in a circle, particles 14 of the hydrogen storage alloy powder.

The hydrogen storage alloy powder of the negative electrode 4 comprises a rare earth-Mg—Ni-based hydrogen storage alloy, and the composition thereof is expressed by a general formula (I): Ln_{1-α}Mg_{α}(Ni_{1-β}T_{β})γ, where Ln is at least one element selected from a group consisting of La, Ce, Pr, Nd, Pm, Sm, Eu, Gd, Tb, Dy, Ho, Er, Tm, Yb, Lu, Ca, Sr, Sc, Y, Ti, Zr and Hf; T is at least one element selected from a group consisting of V, Nb, Ta, Cr, Mo, Mn, Fe, Co, Al, Zn, Ga, Sn, In, Cu, Si, P and B; and subscripts α, β, and γ are numeric values that satisfy 0.05<α<0.12, 0.05≦β≦0.5, 3.40≦γ≦3.70, respectively.

Furthermore, the hydrogen storage alloy satisfies at least one of three conditions:
(1) the proportion of La in Ln is 30 percent by mass or less;
(2) the proportion of Ca in Ln is 25 percent by mass or less; and
(3) the proportion of Al in the total hydrogen storage alloy is 2.5 percent by mass or less.

The negative electrode 4 can be produced by preparing slurry for a negative electrode, which is made up of hydrogen storage alloy powder, a binder, water, and conductive material as appropriate; applying the slurry for a negative electrode to a negative substrate; and rolling and cutting the negative substrate after the slurry is dried.

The hydrogen storage alloy powder is produced, for example, in the following manner.

First, metal materials are weighed and mixed so as to have the composition expressed by the general formula (I) and satisfy at least one of the conditions (1) to (3). A resulting mixture is dissolved, for example, by a high-frequency melting furnace, and is made into an ingot. The obtained ingot is subjected to heat treatment for heating the ingot under inert gas atmosphere at a temperature of 900 to 1200 degrees centigrade for 5 to 24 hours, to thereby make a crystal structure of the ingot into a superlattice structure such that an AB₅-type structure and an AB₂-type structure are merged. To be short, the crystal structure is made into a Ce₂Ni₇-type structure or structure similar thereto. Then, the ingot is pulverized and the particles obtained are sieved to separate those of desired particle size as hydrogen storage alloy powder.

Compared to an AB₅-type hydrogen storage alloy, the above-mentioned hydrogen storage alloy is capable of storing a large amount of hydrogen per unit volume and high in capacity, since the above-mentioned hydrogen storage alloy comprises a rare earth-Mg—Ni-based hydrogen storage alloy.

Further, the hydrogen storage alloy not only has the composition expressed by the general formula (I) but also satisfies at least one of the conditions (1) to (3). Therefore, the hydrogen storage alloy has a true density of 8.0 g/cm³ or more.

More concretely, in the composition expressed by the general formula (I), elements that effect a noticeable change in true density of a rare earth-Mg—Ni-based hydrogen storage alloy are Mg>Ca>Al>La in the order in which rate of change is great. The true density is decreased as the mass ratios of these elements in a hydrogen storage alloy are raised. In this context, relationship between the true density of the hydrogen storage alloy and the mass ratios of the elements in the hydrogen storage alloy is expressed by the following relational expression:
True density=8.87−0.18×A−0.25×B−0.15×C−0.01×D,
where A is mass ratio of Ca; B is mass ratio of Mg; C is mass ratio of Al; and D is mass ratio of La.

Regarding the hydrogen storage alloy having the composition expressed by the general formula (I), if the mass ratios of Ca, Mg, Al, and La that effect a noticeable change in true density are regulated based upon the above relational expression, it is possible to achieve a true density of 8.0 g/cm³ or more.

A reason that the great mass ratios of Ca, Mg, Al and La lead to inversely proportionately small true density is because a crystal lattice expands when the mass ratios of these elements are increased. It is unknown, however, what causes the expansion of the crystal lattice.

As described above, the hydrogen storage alloy has high true density, as compared to conventional rare earth-Mg—Ni-based hydrogen storage alloys, and is then capable of storing a large amount of hydrogen per unit volume. Accordingly, the hydrogen storage alloy is higher in capacity than conventional rare earth-Mg—Ni-based hydrogen storage alloys. If the hydrogen storage alloy is applied to a negative electrode, it is possible to achieve the miniaturization and capacity enhancement of alkaline storage batteries.

If, in the general formula (I), the numeric value of α is set to be greater than 0.05, the hydrogen storage alloy can store a large amount of hydrogen. For this reason, the numeric value of β is set to be greater than 0.05.

In the general formula (I), subscript β is the amount of Ni substituted by a substitute element T. If the numeric value of β is too high, the crystal structure of the hydrogen storage alloy is changed, and the hydrogen storage alloy starts losing the capability of storing and discharging hydrogen. At the same time, the substitute element T begins to dissolve into an alkaline electrolyte solution and form a compound. The compound is deposited on the separator, which degrades long-term preservation performance of batteries. Therefore, β is so determined as to satisfy 0.05≦β≦0.5.

In the general formula (I), if the numeric value of γ is too high, this decreases the number of hydrogen storage sites in the hydrogen storage alloy, so that the hydrogen storability starts to decline. Therefore, the numeric value of γ is set to be 3.70 or less.

### EXAMPLE

Metal materials are weighed and mixed with each other according to compositions shown in TABLE 1. A resulting mixture is dissolved by a high-frequency melting furnace, to thereby obtain ingots of Examples 1 to 7 and Comparative Examples 1 to 3. These ingots are heated under argon atmosphere at a temperature of 1000° C. for 10 hours to make crystal structures of the ingots into superlattice structures such that AB₅-type and AB₂-type structures are merged. Thereafter, test pieces having prescribed size are produced from the ingots, and true densities of the test pieces are measured. TABLE 1 shows results with Al concentrations in alloys. The hydrogen storage alloys of Examples and Comparative Examples each contains as Ln two or more elements selected from La, Ca and Y. TABLE 1 also shows mass ratios of these elements in Ln.

TABLE 1

| | | Mass ratio | Mass ratio | Mass ratio | Mass ratio | True |
|---|---|---|---|---|---|---|
| | | of La in | of Ca in | of Y in Ln | of Al in | density |
| | Composition | Ln (%) | Ln (%) | (%) | alloy (%) | (g/cm³) |
| Example 1 | Ln0.91Mg0.09(Ni0.88Co0.04Al0.08)3.62 | 50.5 | 2.2 | 47.3 | 2.60 | 8.01 |
| Example 2 | Ln0.90Mg0.10(Ni0.88Co0.04Al0.08)3.67 | 27.6 | 3.4 | 69.0 | 2.60 | 8.02 |
| Example 3 | Ln0.90Mg0.10(Ni0.91Co0.04Al0.05)3.56 | 32.7 | 3.4 | 63.9 | 1.50 | 8.17 |
| Example 4 | Ln0.89Mg0.11(Ni0.94Co0.04Al0.02)3.70 | 0.0 | 14.5 | 85.5 | 0.10 | 8.01 |
| Example 5 | Ln0.90Mg0.11(Ni0.91Co0.04Al0.04)3.55 | 27.6 | 3.4 | 69.0 | 1.50 | 8.16 |
| Example 6 | Ln0.90Mg0.10(Ni0.91Co0.04Al0.04)3.55 | 27.6 | 3.4 | 69.0 | 1.50 | 8.17 |
| Example 7 | Ln0.90Mg0.09(Ni0.91Co0.04Al0.04)3.55 | 27.6 | 3.4 | 69.0 | 1.50 | 8.20 |
| Comparative | Ln0.93Mg0.07(Ni0.89Co0.04Al0.07)3.65 | 40.0 | 28.0 | 32.0 | 2.60 | 6.97 |
| Example 1 | | | | | | |
| Comparative | Ln0.87Mg0.13(Ni0.89Co0.04Al0.07)3.48 | 28.6 | 24.5 | 46.9 | 2.60 | 7.03 |
| Example 2 | | | | | | |
| Comparative | Ln0.89Mg0.11(Ni0.95Co0.04Al0.01)3.19 | 28.6 | 23.7 | 47.7 | 0.20 | 7.40 |
| Example 3 | | | | | | |

TABLE 1 demonstrates the following matters.

It is apparent from a comparison between Comparative Example 1 and Example 1 that the true density of the alloy is vastly increased by reducing the amount of Ca contained in Ln. Moreover, Example 2 shows that the true density of the alloy is upgraded by reducing the amount of La contained in Ln. Example 3 shows that the true density of the alloy is increased by reducing the amount of Al contained in Ln.

TABLE 1 also indicates that even if the amounts of Ca, La or Al are small, the true densities are not sufficiently increased when the numeric value of α is too high in Comparative Example 2 and when that of γ is too low in Comparative Example 3.

Example 4 indicates that even if a particular element (Ca in this example) cannot be reduced, the true density of the alloy can be improved by reducing other elements (La and Al in this example). A method of maintaining the amount of a particular element and reducing the amounts of other elements is considered effective when the true density of the alloy needs to be increased while preserving a balance of properties or when the true density of the alloy needs to be raised while keeping low-cost elements contained.

According to Examples 5, 6 and 7, the true density is increased by reducing the numeric value of α. TABLE 1 also shows that the true density is increased more in the case where the numeric value of α is reduced from 0.10 to 0.09 than in the case where the numeric value of α is reduced from 0.11 to 0.10. In both the cases, the reduction is 0.01 in terms of numeric value. However, the reduction from 0.11 to 0.10 decreases the amount of Mg in the total alloy by 9.1 percent, whereas the reduction from 0.10 to 0.09 decreases 10.0 percent and is then very effective.

The present invention is not limited to the one embodiment and Examples thereof, and may be modified in various ways.

In the one embodiment, Ln is at least one element selected from a group consisting of La, Ce, Pr, Nd, Pm, Sm, Eu, Gd, Tb, Dy, Ho, Er, Tm, Yb, Lu, Ca, Sr, Sc, Y, Ti, Zr and Hf. When Ce is selected as Ln, it is preferable that the atomic ratio of Ce in Ln be not higher than 0.2. This is because, if the mass ratio of Ce is higher than 0.2, the hydrogen storability of the hydrogen storage alloy is degraded.

According to the one embodiment, the numeric value of α falls in the range of 0.05<α<0.12. It is preferable, however, that that numeric value of a be within the range of 0.05<α<0.10, and it is more preferable that the numeric value of a be within the range of 0.05<α≦0.09.

Although in the one embodiment, the mass ratio of Ca in Ln is 25 percent or less, it is preferable that the mass ratio be 15 percent or less, and it is more preferable that the mass ratio be 5 percent or less.

Lastly, the hydrogen storage alloy of the present invention can be applied not only to a nickel-metal hydride storage battery but also to an alkaline storage battery in which the electrode includes hydrogen storage alloy powder. Furthermore, it is also possible to apply the hydrogen storage alloy to a hydrogen tank for a fuel cell and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydrogen storage alloy having a composition,
the composition being expressed by a general formula:
Ln_{1-α}Mg_{α}(Ni_{1-β}T_{β})_{γ},
(where Ln is at least one element selected from a group consisting of La, Ce, Pr, Nd, Pm, Sm, Eu, Gd, Tb, Dy, Ho, Er, Tm, Yb, Lu, Ca, Sr, Sc, Y, Ti, Zr and Hf; T is at least one element selected from a group consisting of V, Nb, Ta, Cr, Mo, Mn, Fe, Co, Al, Zn, Ga, Sn, In, Cu, Si, P and B; and subscripts α, β, and γ are numeric values that satisfy 0.05<α<0.12, 0.05≦β≦0.5, 3.40≦γ≦3.70, respectively), wherein:
at least one of three conditions is satisfied, that is,
(1) the proportion of La in Ln is 30 percent by mass or less;
(2) the proportion of Ca in Ln is 25 percent by mass or less;
(3) the proportion of Al in said hydrogen storage alloy is 2.5 percent by mass or less.

2. The hydrogen storage alloy according to claim 1, wherein:
the proportion of Ca in Ln is 15 percent by mass or less.

3. The hydrogen storage alloy according to claim 2, wherein:
the proportion of Ca in Ln is 5 percent by mass or less.

4. The hydrogen storage alloy according to claim 1, wherein:
α in the general formula is less than 0.10.

5. The hydrogen storage alloy according to claim 4, wherein:
the proportion of Ca in Ln is 15 percent by mass or less.

6. The hydrogen storage alloy according to claim 5, wherein:
the proportion of Ca in Ln is 5 percent by mass or less.

7. The hydrogen storage alloy according to claim 4, wherein:
α in the general formula is equal to or less than 0.09.

8. The hydrogen storage alloy according to claim 7, wherein:
the proportion of Ca in Ln is 15 percent by mass or less.

9. The hydrogen storage alloy according to claim 8, wherein:
the proportion of Ca in Ln is 5 percent by mass or less.
